(19) United States
(12) Patent Application Publication
(10) Pub. No.: US 2009/0287318 A1
(43) Pub. Date: Nov. 19, 2009

(54) CONFIGURATION AND DISPLAY MODULE FOR BUS-NETWORKED STATIONS

(75) Inventor: Georg Reidt, Swisttal (DE)

Correspondence Address: DARBY & DARBY P.C., P.O. BOX 770, Church Street Station, New York, NY, 10008-0770, US

(73) Assignee: Moeller GmbH, Bonn (DE)

(21) Appl. No.: 12/357,125

(22) Filed: Jan. 21, 2009

(30) Foreign Application Priority Data
Jan. 17, 2008 (DE) 10 2008 004 798.8

(51) Int. Cl. G05B 19/042

(52) U.S. Cl. 700/3

(57) ABSTRACT

A system for configuring slave stations connected to a bus configured to have a predefined number of slave stations connected thereto includes at least one master station, and a configuration module connected to the bus and configured to receive a query from the master station at a beginning of a configuration process. The configuration module is configured to provide information corresponding to a configuration of the slave stations connected to the bus. The configuration module has a plurality of mechanical setting devices, a number of the mechanical setting devices corresponding to the predefined number of slave stations connectable to the bus. Respective positions of the mechanical setting devices indicate a sequence of the slave stations connected to the bus.

### CROSS REFERENCE TO PRIOR APPLICATIONS

Priority is claimed to German Patent Application No. 10 2008 004 798.8, filed on Jan. 17, 2008.

### FIELD

The present invention relates to an arrangement to configure stations in a bus having at least one master station, whereby a predefined number of slave stations can be connected to said bus.

### BACKGROUND

In bus systems such as, for instance, the field buses CANopen, Profibus DP or Devicenet, so-called field devices or bus stations are networked with each other in terms of data. The stations are usually connected via data cables that are connected from one station to the next, in most cases forming a linear structure. In this context, the system can include a number of slaves (stations) and of at least one or more master stations. The data among the individual stations is exchanged by means of a defined protocol. The basic elements in these protocol definitions are usually Request, Response, Error- and Command PDUs (PDU=protocol description unit) that serve to effectuate the explicit data exchange among certain stations. A central element here is that the slaves have an unambiguous identification so that the sender and the recipient(s) can be determined in the appropriate PDUs for the data exchange. In the above-mentioned field bus systems, this is achieved in that each field bus station is assigned an unambiguous node address. These possible node addresses have a certain range (for example, in CANopen, 1 to 128). Here, in the entire bus system, a given node address can only be assigned to one single station.

A node address is normally assigned to a bus station either by means of a mechanical switch or else by a data interface on the device employing a software tool in conjunction with a PC. In the first case, the device usually has at least one 8-pole DIL switch (binary coded address setting) or one to two rotary switches for setting decimal (0 to 9) or hexadecimal (0 to F) addresses. Consequently, the address can be easily set on the device and read off at any time from a bus station without the need for special auxiliary means.

The second possibility provides for the address to be assigned by means of a software tool. The appertaining bus stations then no longer have an address switch, but rather, a data interface to which, for example, a PC or a configuration tool can be connected. The previously set address can then be read into the bus station via the data interface and remanently stored in the software tool or in the configuration tool. The second possibility entails the advantage that address switches can be dispensed with. Here, it can be a drawback that the set node address cannot be easily read off from the station or checked from the outside.

The above-mentioned methods for setting the addresses apply to field bus systems in which the node addresses of the bus stations are assigned logically. This means that the sequence in which the devices (stations) are connected to the field bus is independent and can be undertaken at will. The node address, however, has to be assigned to each individual device manually.

Another possibility consists of assigning and setting the node addresses automatically, for example, by means of a master station.

Such a method is described in German patent application DE 199 135 192 A1. In this method, the physical position of the bus stations in the linear structure of the bus determines which address the master will allocate to each node. In other words, in this case, the master determines which node addresses and which sequence of node addresses will be assigned (e.g. 1, 2, 3, 4, . . . or 1, 4, 7, 10, . . . ). A system for networking industrial switching devices is described German patent application DE 102006 030706 A1, for example, could assign addresses to the stations in an ascending order from 1 to 16.

For instance, there are industrial switching installations that, among other things, are equipped with bus-networked systems and components and that have a certain basic functionality. These switching installations can be configured, for example, in the form of a switching cabinet in which the bus components are installed. Such installations are typically developed by a switching cabinet manufacturer and then set up, installed and put into operation at the customer's premises. If an installation needs to be functionally expanded over the course of time, the installation is fitted with new electric components at the customer's premises. These could also be, for instance, field bus devices in the form of bus stations. If the installation has a field bus system in which the node addresses of the field devices are assigned logically (that is to say, the setting is carried out directly on the device), then a previously reserved and free node address is selected when the field device is retrofitted. All of the other node addresses are retained, so that the superordinated control software and the defined memory areas and assigned destination addresses can be retained. All that needs to be done is to process the data or the memory areas of the new station, which are naturally assigned to the reserved node address.

There are, however, also bus systems in which the master automatically assigns a node address to the slave stations during the configuration process. An advantage of such systems is that the slaves do not require an explicit setting possibility for a node address (e.g. DIP switch, rotary switch, data interface and the like). Such a method is described, for example, in the above-mentioned German patent application DE 199 135 192 A1. Since the address assignment is automated and has to work for systems having different numbers of stations, this process follows a certain regularity. One possibility is that the stations that are networked in a linear structure are addressed consecutively from 1 to n relative to their physical position as seen starting from the master, wherein n stands for the total number of stations connected to the bus.

If a field bus component or field bus device is installed retroactively in such a system, the addresses of all of the subsequent field bus stations shift by one. The example below is meant to illustrate this situation in a system having 8 stations.

A bus system is being presented here in which the master automatically assigns addresses to the stations. The 8 slave stations are assigned addresses in ascending order from 1 to 8 (Ad1 to Ad8) by the master.

| Master | T1 | T2 | T3 | T4 | T5 | T6 | T7 | T8 |
|---|---|---|---|---|---|---|---|---|
| | Ad1 | Ad2 | Ad3 | Ad4 | Ad5 | Ad6 | Ad7 | Ad8 |

The existing system is now going to be expanded by a new, ninth station between station T4 and station T5. The new station T9 first has to be integrated into the system by the master.

| Master | T1 | T2 | T3 | T4 | T9 | T5 | T6 | T7 | T8 |
|---|---|---|---|---|---|---|---|---|---|
| | Ad1 | Ad2 | Ad3 | Ad4 | Ad? | Ad5 | Ad6 | Ad7 | Ad8 |

During the re-configuration process, the master consecutively assigns addresses to the stations according to the same sequence. Since the total number of stations on the bus is nine, they are now assigned addresses from 1 to 9. The following allocation results from this:

| Master | T1 | T2 | T3 | T4 | T9 | T5 | T6 | T7 | T8 |
|---|---|---|---|---|---|---|---|---|---|
| | Ad1 | Ad2 | Ad3 | Ad4 | Ad5 | Ad6 | Ad7 | Ad 8 | Ad9 |

The new configuration of the bus system causes the new station T9 to be given the corresponding node address of the physical position 5 in the bus network and causes the addresses of the nodes situated beyond this to be increased by one (with respect to the old address). In the data mapping in the master, this likewise results in an incorrect allocation of the data for stations T5 to T8, and the station T9 even receives the data allocation that station T5 had had before, since the data of each slave station is naturally linked to the unambiguous node address. The new addressing of the bus stations will always transpire according to the same scheme in which the master consecutively numbers all of the stations in ascending order from 1 to n because the master does not have any information about the installation position of the new station(s).

If the configuration in the master is to be adapted to the new situation, this could be done by means of a device (e.g. a PC) that is connected in terms of data to the master. This first alternative presupposes that an optional device or PC is available and that it is in operation. Furthermore, the master has to have a data interface for the connection of the device or PC.

In a second alternative, electric switches are present in the master whose switch settings are evaluated by the master prior to the configuration process. This second alternative entails the need for additional hardware resources and for space in the master, which also translates into additional costs for the master. If no configuration possibility were to be used in a system, that is to say, if the master were to always consecutively assign the addresses linearly in ascending order from 1 to n, the device would be needlessly overdimensioned functionally.

Arrangements are known for configuring stations in a bus having at least one master station to which a predefined number of slave stations can be connected (U.S. Pat. Appl. No. 2004/0030459 A1; German application DE 4211650 A1). For this purpose, a configuration module that can be queried by the master at the beginning of the configuration process is inserted into the bus, said module providing information about the configuration of the stations on the bus.

### SUMMARY

An aspect of the present invention is to provide an arrangement with which simple means and settings can be used to expand the bus system with additional stations.

In an embodiment, the present invention provides a system for configuring slave stations connected to a bus configured to have a predefined number of slave stations connected thereto. The system includes at least one master station, and a configuration module connected to the bus and configured to receive a query from the master station at a beginning of a configuration process. The configuration module is configured to provide information corresponding to a configuration of the slave stations connected to the bus. The configuration module includes a plurality of mechanical setting devices, a number of the mechanical setting devices corresponding to the predefined number of slave stations connectable to the bus. Respective positions of the mechanical setting devices indicate a sequence of the slave stations connected to the bus.

### BRIEF DESCRIPTION OF THE DRAWINGS

The present invention will be explained in greater detail below, for which purpose reference will be made to several figures. In the drawings:

FIG. 1 shows a configuration module in accordance with an embodiment of the present invention;

FIG. 2 shows a bus system with 16 stations in accordance with an embodiment of the present invention;

FIG. 3 shows a bus system for 16 stations with 5 currently connected stations in accordance with an embodiment of the present invention;

FIG. 4 shows four additional stations added to the bus system shown in FIG. 3; and

FIG. 5 shows a configuration module with data interface and additional setting and display means in accordance with an embodiment of the present invention.

### DETAILED DESCRIPTION

In an embodiment, the present invention provides a configuration module (also known as “CFG station”) that can be queried by the master at the beginning of a configuration process and that is equipped with mechanical setting means is inserted into the bus, said module providing information in the form of a data telegram about the configuration of the stations on the bus. The configuration module provides information about the total number of stations that can be connected to the bus as well as about the sequence of stations that are present on or absent from the bus.

The configuration module that is inserted into the bus has setting means for each slave station position, and it is possible to indicate whether or not a slave station is physically present at a possible slave station position.

The arrangement being presented here allows gaps to be created in the automatic assignment of addresses to slave stations, so that later, additional stations (devices) can optionally be installed into the bus system, without the node addresses and thus data areas having to shift in the master of the subsequent stations. In this context, the target configuration (that is to say, the number of stations connected to the bus and the corresponding node addresses) is not carried out directly on the master, but rather, via the configuration module. There are plug-in connections on the configuration module for establishing a connection to the bus. This could be, for example, a connection for the bus input and a connection for the bus output. In this manner, the configuration module can be installed in the bus system in any desired place.

The configuration can be prescribed by mechanical setting means on the configuration module.

The setting means include selector switches whose number defines the total number of stations that can be connected to the bus and whose switch position defines the sequence of stations that are present on or absent from the bus. The selector switches are binary switches, whereby a first switch position conveys information about the presence of a station while a second switch position conveys information about the absence of a station.

The principle according to an embodiment of the present invention includes providing the master, via selector switches, with information about how many stations there are and which gaps are present in the assignment of addresses to the slave stations, as a result of which the target configuration for the assignment of addresses to the slave stations on the bus structure is defined. The information is transmitted through the position of the selector switches and this position results from the individual ON and OFF positions. The simplest form of selector switches for node addresses can be DIP switches.

The communication activity with the master can be expanded by means of a configuration module equipped with additional functions. Such an expansion can consist of the fact that the configuration module is provided with a data interface and that setting means (or switch elements) for various states and/or parameters are arranged on the configuration module. A switch (for instance, a rotary switch) can be provided as the setting means via which information (states, settings or parameter transfers) can be transmitted to the master. Such information can be, for example, a change from one operating mode to another that the master is supposed to adopt or it can be a certain behavior that the master is supposed to have in case of an error in the bus operation. Status messages and displays of state changes can be effectuated using optical means (such as LEDs or an LCD display) on the configuration module. For example, if one wanted to display the binary status of each station of the bus, the configuration module could request the pertinent data via a PDU, evaluate said data and display it with the optical means.

In a preferred embodiment, the configuration module is designed in such a way that it can send, receive and process data telegrams from the bus. A bidirectional communication functionality is possible.

Moreover, the optical display means are to be associated with the data that has been received and processed so that they serve to display status messages.

A data interface on the configuration module makes it possible to connect an intelligent external device (as an interface module). Such a device can include a PC, a PDA, a mobile telephone or a similar intelligent electronic system. It would then be possible to evaluate, display and/or further process the transmitted data in the external device.

The present invention is primarily intended for the continuous operation and use of the configuration module with a master and slaves on a bus, so that, after each switch-on instance, the master can request the configuration specifications via the configuration module. However, it is also possible for the configuration module to be only connected to the bus temporarily in order to assign a configuration. In such a case, the master will remanently store the prescribed configuration from the configuration module. For this purpose, this property is implemented in advance in the master logic. The primary configuration is only changed when a configuration module with a specification that is new in comparison to the old stored specification is once again temporarily connected.

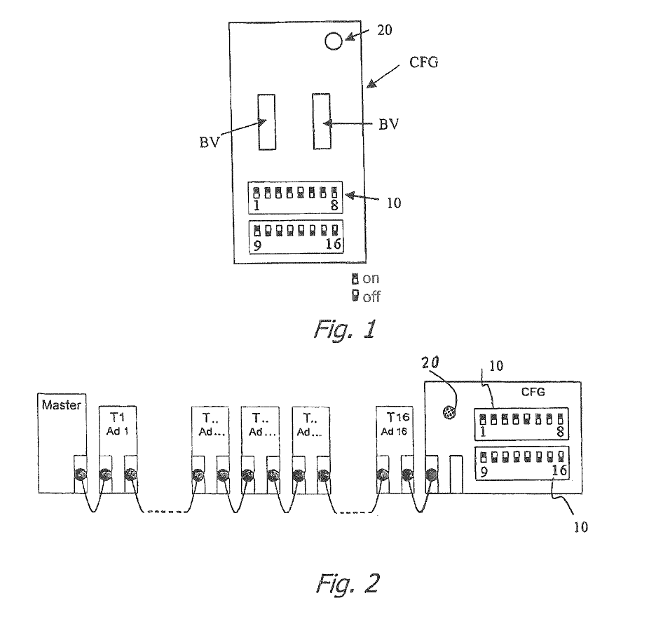

According to an embodiment of the present invention, a configuration module is inserted into the bus structure so that, after the power supply has been switched on, the master can call up information from the configuration module. As shown in FIG. 1, the configuration module CFG has an input and an output as bus connections BV. The configuration module can be inserted into the bus at any desired place; it is not counted as a station on the bus. Sixteen DIP switches are provided as selector switches 10. The total number of stations that can be connected to the bus is prescribed by the number of switches, whereby 16 (in FIG. 1) is to constitute the total number (n=16) of possible slave stations. The switch position indicates the presence or absence of a station on the bus. The following allocation applies: switch ON=station present; switch OFF=station absent. Thus, the target configuration specification for the controlling master can easily be made in this manner, whereby the master firstly obtains information about the number of slave stations and secondly about any address gaps that might exist.

At the beginning of a configuration, the master does not start directly with the assignment of addresses to the slave stations, but rather, it first queries by means of an unambiguous PDU whether a configuration module is present on the bus. The PDU is defined in the protocol definition of the bus system as a data telegram (data frame) with an unambiguous identification and it is only used to query the configuration module. If the master receives a response to this query (likewise as PDU), then it is known that a configuration module is present on the bus.

In the absence of a response, it is evident that no configuration module is connected to the bus. In this case, every time that the power supply is switched on, the master will ascertain that this situation is present and will start the configuration process for an automatic address assignment and will consecutively assign addresses to all of the slave stations. This, in turn, would be carried out in accordance with a method known from the state of the art.

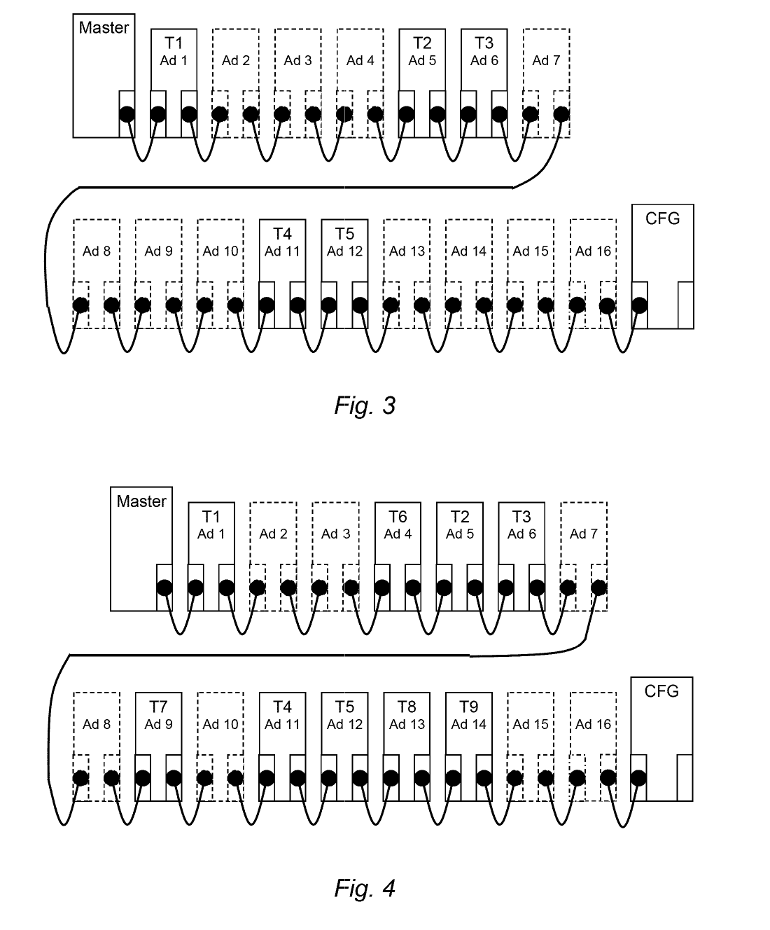

The principle according to an embodiment of the present invention will now be elaborated upon in greater depth with reference to FIG. 2. The example described above including a master and initially 8 stations will be used for this purpose. The slave stations are arranged in a linear structure in the bus system. In addition, a configuration module CFG was connected to the last place in the bus system. It is however, possible for it to be placed elsewhere in the bus system. The configuration module CFG in this example has 16 DIP switches, which means that the master can assign addresses to and operate up to 16 stations.

As mentioned, the switch position indicates the presence or absence of a station on the bus. Eight stations (T1 to T8) are present on the bus. The ascending consecutive numbering of the ON switch positions indicates how the master consecutively assigns addresses to the stations T1 to T8. Only the switches that are in the ON switch position provide valid values.

Of the 16 DIP switches, numbers 1 to 4 and numbers 6 to 9 are set to ON on the configuration module CFG. The fact that DIP switch 5 and switches 10 to 16 are set to the OFF position means that a station can be inserted into each of these physical positions 5 as well as 10 to 16 in the bus.

| Master | T1 | T2 | T3 | T4 | T5 | T6 | T7 | T8 | CFG |
|---|---|---|---|---|---|---|---|---|---|
| | Ad1 | Ad2 | Ad3 | Ad4 | Ad6 | Ad7 | Ad8 | Ad9 | |

If an additional (new) station is inserted into the physical position 5 in the bus, in other words, between the fourth and fifth stations, only DIP switch 5 needs to be switched from OFF to ON.

After the ninth station has been inserted, the sum of ON switch positions is nine and the new address sequence that the master allocates when the bus system is re-configured is 1, 2, 3, 4, 5, 6, 7, 8 and 9.

The depiction below shows the allocation after the ninth station T9 has been inserted and after the master has carried out the new configuration of the bus, with a CFG station:

| Master | T1 | T2 | T3 | T4 | T9 | T5 | T6 | T7 | T8 | CFG |
|---|---|---|---|---|---|---|---|---|---|---|
| | Ad1 | Ad2 | Ad3 | Ad4 | Ad5 | Ad6 | Ad7 | Ad8 | Ad9 | |

The insertion of station T9 at position 5 (with address 5) is possible retroactively due to the previously defined gap for address 5, without the addresses and thus the data areas for the stations T5 to T8 having to shift in the master.

The simplicity and flexibility of the configuration will be demonstrated in FIGS. 3 and 4 on the basis of another example.

FIG. 3 shows a bus system with a master, with the configuration module CFG and with five slaves. Altogether, it should be possible to connect 16 stations (not counting the configuration module) to this bus. The configuration module has 16 DIP switches. The broken lines depicting the stations in gaps 2 to 4, 7 to 10 and 13 to 16 indicate that additional stations can be integrated at these places.

If four more stations (T6 to T9) are then inserted into positions 4, 9, 13 and 14 in this system, then switches 4, 9, 13 and 14 have to be switched to ON on the configuration module. The new configuration is shown in FIG. 4. The master can request this configuration from the configuration module via a PDU or via a data telegram.

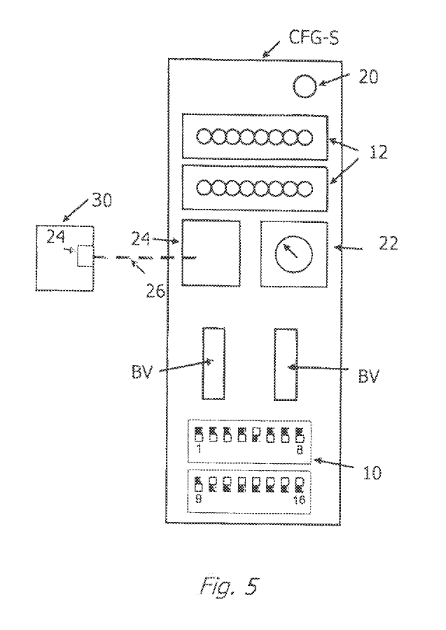

FIG. 5 shows a configuration module CFG-S having additional setting and display possibilities, as a result of which the functionality between the configuration module and the master is expanded. A setting means in the form of a rotary switch 22 is arranged on the configuration module CFG-S (according to FIG. 5). The states and/or parameters that are transmitted to the master can be set by means of the rotary switch 22. It has already been mentioned that such information refers, for instance, to the change from one operating mode to another that the master is supposed to adopt or to a certain behavior that the master is supposed to have in case of an error in the bus operation. State changes can be displayed by optical means 12 (such as LEDs or an LCD display) on the configuration module. Another optical means 20 serves to display the operating status of the configuration module CFG-S.

The data interface 24 on the configuration module CFG-S makes it possible to communicate with an intelligent device 30 via a data line 26. The transmitted data can be evaluated, displayed and/or further processed in the external device 30 (a PC, a PDA, a mobile telephone or a similar electronic system).

The present invention is not limited to the embodiments described herein; reference should be had to the appended claims.

### LIST OF REFERENCE NUMERALS

Ad1 . . . station address
Adn
BV bus connection (input, output)
T1 . . . Tn stations (slaves)
CFG configuration module
CFG-S configuration module with data interface
10 mechanical setting means (DIP switches)
12 optical display means
20 optical display means (LED)
22 mechanical setting means (rotary switches)
24 data interface
26 data line
30 external device (electronic system)

1-12. (canceled)

13. A system for configuring slave stations connected to a bus configured to have a predefined number of slave stations connected thereto, the system comprising:
at least one master station; and
a configuration module connected to the bus and configured to receive a query from the master station at a beginning of a configuration process, the configuration module configured to provide information corresponding to a configuration of the slave stations connected to the bus, the configuration module having a plurality of mechanical setting devices, a number of the mechanical setting devices corresponding to the predefined number of slave stations connectable to the bus, respective positions of the mechanical setting devices indicating a sequence of the slave stations connected to the bus.

14. The system as recited in claim 13, wherein the information includes the predefined number of slave stations connectable to the bus and the sequence of the slave stations connected to the bus.

15. The system as recited in claim 14, wherein the configuration module is configured to provide the information by transmission in a form of a data telegram via the bus.

16. The system as recited in claim 13, wherein the information provided by the configuration module is storable by the master station.

17. The system as recited in claim 13, wherein the mechanical setting devices include binary switches having a first position indicating a presence of a slave station and a second position indicating an absence of a slave station.

18. The system as recited in claim 13, wherein the configuration module includes a setting element configured to transmit settings or parameters to the master station.

19. The system as recited in claim 18, wherein the setting element is configured to permit selection of parameters.

20. The system as recited in claim 19, wherein the selection of parameters includes at least one of an operating mode and a behavior the master station in an error condition.

21. The system as recited in claim 18, wherein the setting element includes a rotary switch.

22. The system as recited in claim 13, wherein the configuration module is configured to send, receive, and process data via and from the bus.

23. The system as recited in claim 13, wherein the configuration module includes an optical device configured to display a status message.

24. The system as recited in claim 13, wherein the configuration module includes a data interface for a data line connected an external system.

25. The system as recited in claim 13, wherein the configuration module includes at least one plug-in connection to connect to the bus.
